(19) United States
(12) Patent Application Publication
(10) Pub. No.: US 2021/0117075 A1
(43) Pub. Date: Apr. 22, 2021

(54) SYSTEM AND METHOD FOR MANAGING STRUCTURAL ENVIRONMENTS USING A RADIAL CHRONOLOGICAL REPRESENTATION

(71) Applicant: Cima Network, Inc., Chalfont, PA (US)

(72) Inventor: Brad Koerner, Amsterdam (NL)

(21) Appl. No.: 17/071,671

(22) Filed: Oct. 15, 2020

Related U.S. Application Data
(60) Provisional application No. 62/916,803, filed on Oct. 18, 2019.

(51) Int. Cl. G06F 3/0484; G06F 3/0486; G06F 3/0481; G06F 3/0488; G06F 16/13; H05B 47/175; H05B 47/16; H05B 47/11

(52) U.S. Cl. CPC G06F 3/04847; G06F 3/0486; G06F 3/04817; G06F 3/0488; H04L 67/12; H05B 47/175; H05B 47/16; H05B 47/11; G06F 16/13

(57) ABSTRACT

A system for managing a structural environment with a user interface having a timeframe identified by a radial chronological representation. By employing a user interface with a timeframe identified by a radial chronological representation, owners and their agents and employees can intuitively coordinate the internal environment of a structure to provide for a more pleasing customer experience. Multiple adjustable environmental components can be managed on the same radial chronological representation of the interface. Furthermore, the system and method can be deployed over multiple locations to create the same internal environmental feel, thereby creating a branded internal environment that a customer will experience no matter the location they enter.

### CROSS-REFERENCE TO RELATED APPLICATION

This application claims the priority and benefit of U.S. Provisional Patent Application Ser. No. 62/916,803, filed Oct. 18, 2019, titled “Lighting control user interface for managing daily cyclic patterns via radial chronological representation”, the entirety of which is incorporated herein by reference.

### TECHNICAL FIELD

The present invention is directed generally to the control of building environments. More particularly, various inventive systems and methods disclosed herein employ a user interface having an intuitively adjustable radial chronological interface to quickly, easily, and automatically manage structural environments such as lighting.

### BACKGROUND

To capitalize on today's rapidly evolving, specialized technologies, architects, designers, builders, and contractors work together to plan the mechanical and electrical systems that controls the environment of a building. Most commercial building system designs, including controls and building automation, are constructed with the individual environments managed from a single command location. Such locations may be the same or different for each environmental control. For example, the lighting control may be located at the same place where an individual may raise or lower window shades, however, the security control may be located at a separate location. The goal of a centralized control location for each environment is simplification of use.

For example, the use of multiple light sources may be simplified by combining the control of one or more light sources into a unified control system. In such lighting control systems, lighting control is organized around a principle of “preset scenes” in which various light sources are set at various light levels and stored as preset discrete scenes. Additional environments such as the building's heating ventilation and cooling (“HVAC”), electrical generation and consumption, security, and vertical transit systems, may also be organized around specific “presets”. These presets are accessed within the environment through either physical or virtual access that recall the preset and deploys the settings to adjust the environment via the use of environmental components. For example, turning down the HVAC, diverting solar power to battery storage, arming security, dimming certain lights, or sending elevators to specifically designated floors. Such scenes or presets may be stagnant or may transition at preprogrammed transition times.

With virtual access, a computer software program or “app” is used for programming the environment. Typically, a hierarchy of individual components within the environment (e.g., light sources for a lighting control system) is established. As a result, single or multiple elements within an environmental component system are organized into “channels” of control. For example, for the lighting component, one channel may include monochromatic light sources, while another channel includes blended multi-source fixtures such as red, green, and blue color mixing units.

Many end users faced with implementing lighting transitions other than just turning lights on or off find the concept of “preset scenes” to be frustratingly difficult to implement or modify. The programming concepts of fixture assignments, channel designation, and scene effect construction and transitions are difficult to coordinate.

In an attempt to avoid such difficulty, some have turned to preloading industry standard scenes. This over simplification of preset scene controls, where a user can only select from a few preloaded scenes on physical or virtual buttons, is opaque as to the intention of the programming and typically provides only limited ability to fine-tune or adjust the scenes without diving back into the complicated programming and commissioning interface, which is often times not available in the physical space itself. Although presets are often intended to simplify routine daily changes in environmental conditions and thereby maximize an occupant's experience, comfort, and safety, often times presets are misused because the users have limited understanding of the design intentions as preset in the system.

Further complicating the matter is the manner by which most timeframes are displayed to a user when creating the presets. Because time is linear, current control units present a linear time scale when creating presets. There are, however, many ways to visualize event sequences as timelines and, like here, a linear visualization is not the best. While a linear presentation may work for a few channels within a single environmental component, today's smart buildings and their interconnection between not only channels but environmental components make integrating environmental controls for maximizing an occupant's experience, comfort, and safety difficult. For example, to save electricity, a user may wish to turn off the building lights after 11:00 pm, however, turning off certain exterior lights may compromise the security environment of the building. Currently a user would have to coordinate the linear timeline of the relevant lights, with the separate linear timeline of the security system. Coordinating such timelines, which as outlined above are likely located at two separate locations within the structure, is difficult.

As a result, there is a need for a system and method, that permits a user to easily visualize, interact, and control multiple environmental components within a structure throughout the course of a day. To streamline interaction, such a system and method makes use of a radial chronological representation of time. As a result, the interface consolidates: (1) time settings, typically a 24-hour daily cycle, but it may also provide for monthly or yearly cycle control for different applications; (2) an effect library, organized around what environmental controls are possible with the different environments within the structure; (3) controls interfaces, to allow easy setting and connection of common discrete architectural environments and their discrete controls such as physical switches, occupancy sensors, daylight sensors, and digital signage; and (4) an easy, user-accessible interface that depicts environmental presets visually organized along the course of a predetermined time period (e.g., a day) in a radial manner that permits easy overlay between the different environmental components.

### SUMMARY

This invention is an intuitive and concise system or a method to control how a building environment changes its programming and control modes throughout the course of a predetermined timeframe—daily cycles, weekly cycles, monthly, seasonal, etc. The device is tied to the ultimate environmental components (i.e., mechanical, electrical, or digital components) either directly, by incorporating various control protocols directly in the device (e.g. DMX or DALI for lighting; KNX for building management, etc.) or through various means back to the individual control systems via appropriate interfaces. Using the system or method disclosed below, a user can intuitively maximize the experience, comfort, and safety of all occupants of a structure from a single location. Furthermore, the user can guarantee that multiple locations can have the same internal environmental feel, thereby creating a branded internal environment that a customer will experience no matter the location they enter.

In certain embodiments, the system and method use the same radial chronological representation of the timeframe to control two, three, four, five, six or more environmental components all from the same user interface.

The system operates on a mobile computer device (e.g., a phone), a computer device, or via a website linked to the phone or computer. The driving force of the system is the radial chronological representation of the timeframe, which permits a user to easily and intuitively schedule at least one environmental component to turn on, off, ramp up, ramp down, or activate/deactivate in some other way (e.g., dim or change color) at set times to create a specific branded look in at least one location of the structure. The branded look could even be synchronized across numerous locations within the structure—or across even more than one structure.

The system comprising a software application operating on a mobile computer device or on a computer device that is synced with the mobile computer device. The software application is configured to receive at least one structure identifier (e.g., building address) and a target environment profile, linked to preferences for a structural environment (e.g., specific light scenes for implementation at specific times of day at a specific location). The building owner or their agents or employees can easily create the target environmental profile using the radial chronological representation. The software application communicates the structure identifier and target environment profile through a wired and/or wireless communication network to a server located at the structure or a location remote to the structure through the wired and/or wireless communication network. The system includes a processor that is in communication through a wired and/or wireless communication network with the software application, the server, and a temporal component. Upon receipt of the structure identifier and the target environment profile the processer retrieves from a database of the system at least one identifier of an adjustable environmental component located at the structure linked to the structural environment (e.g., at least one LED light to be adjusted is identified), which was previously uploaded to the database and linked to the structure environment by the owner, employee or agent of the structure. The processor also obtains a current date and time based on the structure's location. Upon receiving this information, the processor compares the date and time to the target environment profile to determine the current desired operational state of the adjustable environmental component (e.g., should the lights be on/off/purple/dimmed). The processor then compares the current operational state of the adjustable environmental component to the current desired operational state of the adjustable environmental component and adjusts the current operational state of the adjustable environmental component to match the current desired operational state of the adjustable environmental component. To make sure that the structural environment continues to match the desired environment, the processor continuously obtains the date and time of the location of the structure to determine the desired operational state of the adjustable environmental component by comparing the date and time to the target environment profile and when the current operational state of the environmental component does not match the current desired operational state the processor is configured to adjust the current operational state of the adjustable environmental component to match the current desired operational state of the adjustable environmental component.

In certain embodiments, the radial chronological representation is defined by two concentric circles, which may define a twelve or twenty-four hour period. In other embodiments, the radial chronological representation may define a week, month, or year period.

For ease of use, in certain embodiments, the radial chronological representation may include at least two adjustable radial linear dividers designating at least two separate sections of the radial chronological representation. In other embodiments, the radial chronological representation may include three, four, five, six, seven, eight, nine, ten, eleven, twelve, or more adjustable radial linear dividers designating three, four, five, six, seven, eight, nine, ten, eleven, twelve, or more separate sections of the radial chronological representation.

The user interface containing the radial chronological representation may also include a palette having at least two settings for the adjustable environmental components for the structural environment which has been previously uploaded to a database connected to the software application by wired or wireless communication by the owner, or their agents or employees. In other embodiments, the palette may have three, four, five, six, seven, eight, nine, ten, eleven, twelve, or more settings for the adjustable environmental components for the structural environment, which has been previously uploaded to a database connected to the software application by wired or wireless communication by the owner, or their agents or employees.

For ease of use, the user interface may be touch screen enabled thereby allowing an owner, employee or agent of the structure to amend the elements contained in the radial chronological representation by dragging and dropping each setting onto the radial chronological representation or adjusting the location of the adjustable radial linear dividers.

In certain embodiments the system and method utilize at least one sensor adapted to actively monitor the structural environment and continuously transmit data related to the structural environment to the processor. In such embodiments the processor is adapted to actively monitor the current operational state of the adjustable environmental component and the structural environment and determine whether the structural environment matches the current desired operational state. When the current operational state does not match the current desired operational state, the processor is configured to adjust the current operational state of the adjustable environmental component to drive the structural environment to the desired structural environment. Of course, the palette may include a sensor icon and the owner, employee or agent of the structure may schedule the sensor to actively monitor the structural environment at certain times by simply using a touch screen and dragging and dropping the sensor icon onto the radial chronological representation. In certain embodiments multiple sensors may be deployed. Sensors may monitor anything from the temperature, air quality, movement, occupancy of the location, ambient light, or humidity.

In certain embodiments, the processor is further configured to call up from the database of the system at least one emergency threshold (e.g., if internal temperature exceeds 130° F. there is a fire) previously uploaded by the owner, employee or agent of the structure and at least one override environment (e.g., turn on all lights) linked to the emergency threshold and previously uploaded by the owner, employee or agent of the structure. The processor actively monitors the structure environment and upon the structural environment crossing the emergency threshold, within a degree of tolerance, the processor is adapted to adjust the current operational state of the adjustable environmental component to drive the structure environment to the override environment.

A method for managing a structural environment with a user interface having a timeframe identified by a radial chronological representation is also disclosed. The method comprises receiving a structure identifier and a target environment profile linked to preferences for the structural environment. The target environment profile being created by an owner, employee or agent of the structure using the radial chronological representation. Then communicating the structure identifier and target environment profile through a wired and/or wireless communication network. Upon communication of the structure identifier and the target environment profile, receiving at least one identifier of an adjustable environmental component located at the structure linked to the structural environment along with a current date and time. Next, determining the current desired operational state of the adjustable environmental component by comparing the current date and time to the target environment profile. Then comparing the current operational state of the adjustable environmental component to the current desired operational state of the adjustable environmental component. Initially adjusting the current operational state of the adjustable environmental component to match the current desired operational state of the adjustable environmental component. Finally, monitoring, continuously, the date and time of the location along with the current operational state of the adjustable environmental component and determining, continuously, the current desired operational state of the adjustable environmental component by comparing the date and time to the target environment profile and whether the current operational state matches the current desired operational state of the adjustable environmental component. When the current operational state does not match the current desired operational state adjusting the current operational state of the adjustable environmental component to match the current desired operational state of the adjustable environmental component.

### BRIEF DESCRIPTION OF THE DRAWINGS

Additional aspects, features, and advantages of the invention, both as to its structure, assembly, and use, will be understood and will become more readily apparent when the invention is considered in light of the following description of illustrative embodiments made in conjunction with the accompanying drawings, wherein:

FIG. 1 illustrates a screen display example of a radial chronological display showing a setting operation between two different light scenes for a lighting fixture.

FIG. 2 illustrates a screen display example of the radial chronological display of FIG. 1 showing a setting operation between three different light scenes for a lighting fixture using a drag and drop feature of an effect palette.

FIG. 3 illustrates a screen display example showing a setting operation for a sensor within one of two different light scenes for a lighting fixture within the radial chronological display of FIG. 1.

FIG. 4 illustrates a screen display example showing a setting operation for fade in within one of two different light scenes for a lighting fixture within the radial chronological display of FIG. 1.

FIG. 5 illustrates a screen display example showing employing one embodiment of the radial chronological display disclosed herein.

FIG. 6 illustrates a screen display example showing a setting operation for a preset override within a light scene for a lighting fixture employing the radial chronological display of FIG. 1.

### DETAILED DESCRIPTION

Various embodiments of the invention are described in detail below. Although specific implementations related to control of lighting units are described, it should be understood that this disclosure is provided for illustration purposes only. A person skilled in the relevant art will recognize that other components and configurations may be used without parting from the spirit and scope of this disclosure. For example, the system and method can be used to control environmental components such as lights, HVAC, electrical generation and storage infrastructure, security systems, digital signage, window shading, and/or vertical transit components incorporated into a structure.

It should be appreciated that all combinations of the foregoing concepts and additional concepts discussed in greater detail below (provided such concepts are not mutually inconsistent) are contemplated as being part of the inventive subject matter disclosed herein. It should also be appreciated that terminology explicitly employed herein that also may appear in any disclosure incorporated by reference should be accorded a meaning most consistent with the particular concepts disclosed herein. It should also be understood that, unless clearly indicated to the contrary, in any methods claimed herein that include more than one step or act, the order of the steps or acts of the method is not necessarily limited to the order in which the steps or acts of the method are recited.

The present disclosure is generally directed to a system or method for tracking the time of day and/or sensing ambient environmental conditions and adjusting environmental components to adjust the environment within a structure to predetermined desired environmental conditions, previously uploaded by the owner of the building or an agent or employee of the owner of the building using a radial chronological display. Furthermore, the system and method permit different environmental components to be controlled using the same interface employing the adjustable radial chronological timeline instead of a linear timeline. This single chronological representation allows a user to easily and intuitively standardize environmental condition desired by the owner or agent or employee of the owner across at least one location. In this regard, the system and method permit easy intuitive control of a structure's environment and allows multiple structures located at different sites to all have the same environmental feel at the same time.

For example, the system allows for the automatic adjustment of the intensity and/or color temperature of light sources inside or outside of the structure based on the time of day of the location and the ambient light detected at previously designated locations. Indeed, the lighting unit can slowly “fade-in” (i.e. increase over time) during times of anticipated darkness and/or times of detected darkness, and can slowly “fade-out” (i.e., decrease over time) during times of anticipated brightness based on the date and/or time and/or detected brightness based on a sensor. Such fade-in and fade-out permits the lights to track a scene previously uploaded to the system by a building's owner or agent or employee of an owner via an interface having an adjustable radial chronological timeline.

In certain embodiments where the environmental components is a lighting unit including at least one light source, the system includes a temporal component; and a processor operably connected between the environmental component and the temporal component. The processor is configured to receive date and time data as it relates to the location of the structure from the temporal component, and automatically adjust the operational profile of the environmental component to achieve a previously defined structural environmental condition. For example, based on the time of day, the processor can either fade-in or fade-out the intensity profile for light emitted from the light source.

In certain embodiments, the system and method may include at least one sensor located within the environment to be controlled. The sensor is adapted to determine a current ambient environmental condition (e.g., sense ambient light level, occupancy, or temperature). In such embodiments, a processor is operably connected between the light source and both the ambient light level sensor and the temporal component. The processor is configured to receive ambient light data from the sensor and time data from the temporal component, and to automatically select the fade-in or fade-out intensity profile for light emitted from the at least one light source based at least in part upon the ambient light data or the time of day data.

In certain embodiments, the system further comprises a real-time positioning device, such as a global positioning system device (GPS), and the processor is configured to automatically select a preset profile for at least one environmental component based at least in part upon the positional information received from the GPS. For example, an individual that owns restaurants in Florida and Maine can mirror the light scenes for both restaurants so that regardless of location the light level, color, and intensity within both locations is the same at the same time in each location regardless of the fact that the sun rises and sets at different times at each location or that one location is cloudy whereas the other location is sunny. In this way the owner can make sure that regardless of the location a customer visits the interiors always appear the same to the customer.

A method for determining an adjustment to an environmental component to reach a desired environmental condition previously uploaded by a building owner or the building owner's agent or employee is also disclosed. Such a method employs an environmental component (e.g., a lighting unit comprising at least one light source), a sensor, a temporal component, and a processor operably connected between the environmental component and both of the sensor and the temporal component, the method comprising the steps of receiving a current environmental condition level data at the processor from the sensor, receiving time data at the processor from the temporal component, receiving a desired environmental condition, previously uploaded by a building owner or the building owner's agent or employee, determining, using the processor, the necessary adjustments to the environmental component based at least in part on the received sensor data, the temporal data, and performing the determined adjustment to the function of the environmental component.

Certain embodiments also include a method for determining an adjustment to an environmental component to reach a desired environmental condition, previously uploaded by a building owner or the building owner's agent or employee. Such a method employs an environmental component (e.g., a lighting unit comprising at least one light source), a temporal component, and a processor operably connected between the environmental component and the temporal component, the method comprising the steps of receiving time data at the processor from the temporal component, receiving a desired environmental condition, previously uploaded by a building owner or the building owner's agent or employee, determining, using the processor, the necessary adjustments to the environmental component based at least in part on the temporal data, and performing the determined adjustment to the function of the environmental component.

A discussion of the systems and methods surrounding the environmental controls that employ a user interface having an intuitively adjustable radial chronological interface to quickly and easily automatically manage a structure's environments will now occur. First, the definitions used to describe the disclosed system and method are provided. Second, a system overview is provided. Third, the components of the system are discussed. Fourth, a description of a cloud computing system, which is one of the environments in which the system operates is disclosed. Fifth, environmental components, which the system can adjust, are identified.

### DEFINITIONS

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, and luminescent polymers.

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K. Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “lighting scene” as used herein refers to a specific configuration of light sources to achieve a desirable lighting temperature, color, or illumination of a room, surface, space, or other target. The configuration can include, for example, a property of radiation that is perceivable by an observer (although this usage is not intended to limit the scope of this term). For example, properties affected by the configuration can include intensity and color, among many other properties.

### SYSTEM OVERVIEW

The disclosed system and method centers around a radial chronological display 100 that permits intuitive creation of and adjustments to environmental presets by an owner of a structure or agent or employee of the owner. The environmental controls may be organized along a daily chronological cycle expressed as the radial configuration. This radial configuration permits an intuitive visual understanding and direct control of effect selection, start and end time settings, and special conditions such as sensor inputs or emergency overrides.

In some embodiments, the system comprise a computer-based feedback system that automatically makes control decisions based on ambient environmental conditions, target environmental conditions previously uploaded by an owner of a structure or an agent or employee of the owner, the offset between a target and a monitored value, the offset duration, whether changes are required in the short term verses long term, sensor input, and/or other appropriate information.

In certain embodiments, accompanying the radial interface is a palette of environmental effects, such as light effects, which may be incorporated into the radial chronological display via an easy “drag and drop” configuration. Additional secondary concepts to simplify effect configuration and provide scene override functionality for convenience or for connecting to other systems such as emergency services may be incorporated into the palette of the graphical user interface.

Turning now to the figures, particular embodiments where lighting systems are the environmental component adjusted by the system and method are described.

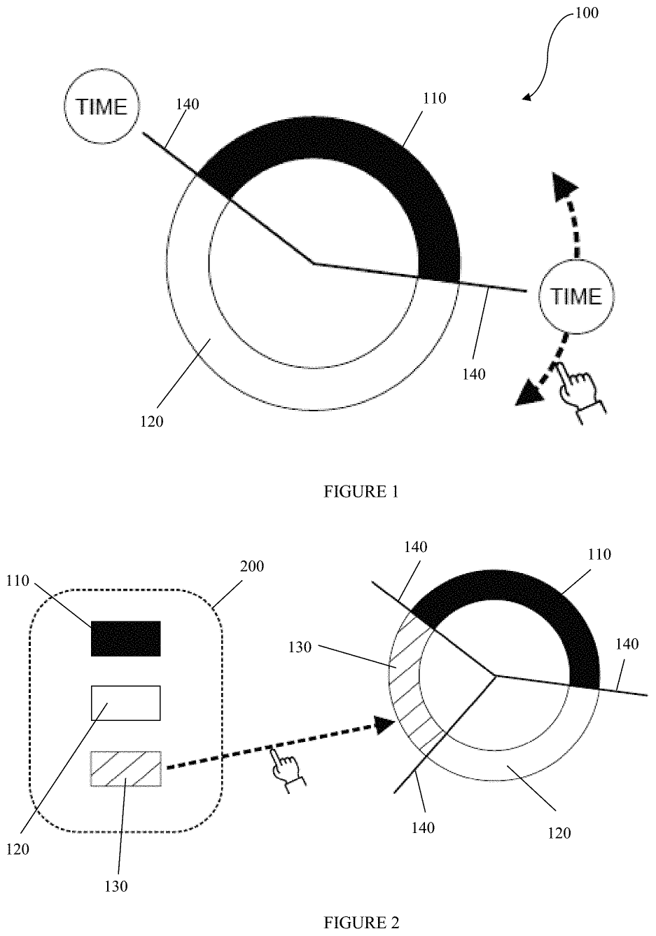

FIG. 1 is a visual representation of a time frame 100 expressed in a circular, radial format. Radial linear dividers 140 sweep around the radial timeline 100, representing time settings for a transition from a first light scene 110 to a second light scene 120. The radial linear dividers can be adjusted by the owner of a structure or the agent or employee of the owner through an interface described below that displays the radial time frame 100. In certain embodiments, the first light scene may be a single light turned off, and the second light scene 120 maybe a single light turned on. The two radial dividers 140 represent when the light scene changes (i.e., when the light turns on or off). In such an embodiment, such as that depicted in FIG. 1, the owner may drag the radial dividers 140 around the radial interface to change the time of the event. In certain embodiments, the time of the transition from the first light scene 110 to the second light scene 120 event maybe be represented in a live readout 150 at the point of the radial divider.

Referring to FIG. 2, in certain embodiments, a lighting effects palette 200 lists or graphically visualizes a collection of a first, second, or third lighting scene 110, 120, 130. Again, as depicted in FIG. 2, a lighting effect 130 may be dragged onto the radial timeline 100 and be placed between two dividers 140. A user can then drag at least one of the radial dividers 140 to set the start and end times of the light scene 110, 120, 130.

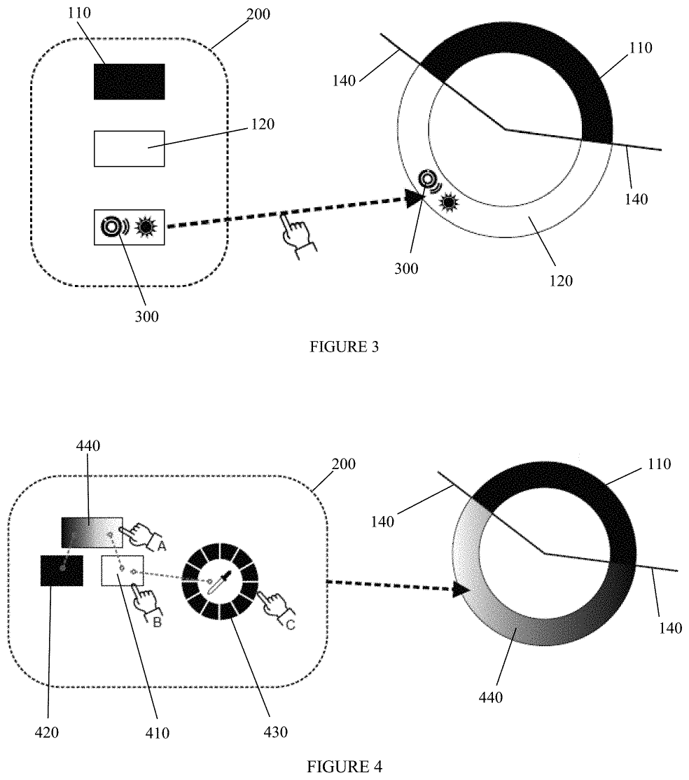

Referring to FIG. 3, in certain embodiments, at least one sensor input 300 may be incorporated into the system or method. The sensor 300 may be adapted to control a light scene 120. For example, based on the data provided by the sensor 300 related to the ambient light level within the structure, the system may fade in or fade out the light so as to maintain a specific light intensity. As depicted in FIG. 3, the sensor input 300 may be listed or depicted graphically in the lighting effects palette 200 of the graphical user interface. Again, the sensor 300 input function may be dragged onto the radial timeline 100 to control a specific light scene 120. The parameters of the sensor 300 or data input may be set by selecting the function in the effect's palette 200 via a touch, such as a long press, or double click.

Referring to FIG. 4, a light scene 120 may be a variable light scene. In other words, the color, intensity or temperature of the light scene 120 may change over time. The owner or their agent or employee may set the variable scene from the user interface. Such setting may occur within the effect's palette 200. Indeed, a user may directly adjust the color, temperature, or intensity of the scene via touch, or clicking on the elements. The available adjustments depend on the type of channel within the environmental component being adjusted. For example, if the adjustment relates to a single monochromatic dimmable channel within the lighting system, the variable may be a scale with 0% 420 representing off up to 100% 410 representing on. For a channel with an adjustable chromatic control, the variable can be a color selection interface 430 such as red, green, blue or hue, saturation, lightness. For a scene with a changing effect such as a fade between two colors 440, the start point, and end point will each have a variable with a color selection interface. The time frame for such a fade-in or fade-out of the environmental component may also be input by the user using the radial timeline 100. For example, the user my set a light fixture to continuously (i.e., at a steady rate) fade in from 0% to 100% over 30 minutes. Conversely, the user may set the environmental component to fade-in at a variable rate over a preset timeframe.

Furthermore, some effects maybe driven with additional data inputs. For example, the variable may attempt to match the color temperature of the lighting to the circadian rhythm of natural daylight based on the location of the structure. In such an embodiment, the effect may reference the specific time of day to a preprogrammed data chart to lookup the desired correlated color temperature. Finally, data streams, such as from a sensor, social media, or other source may be used to map data parametrically to an effect variable.

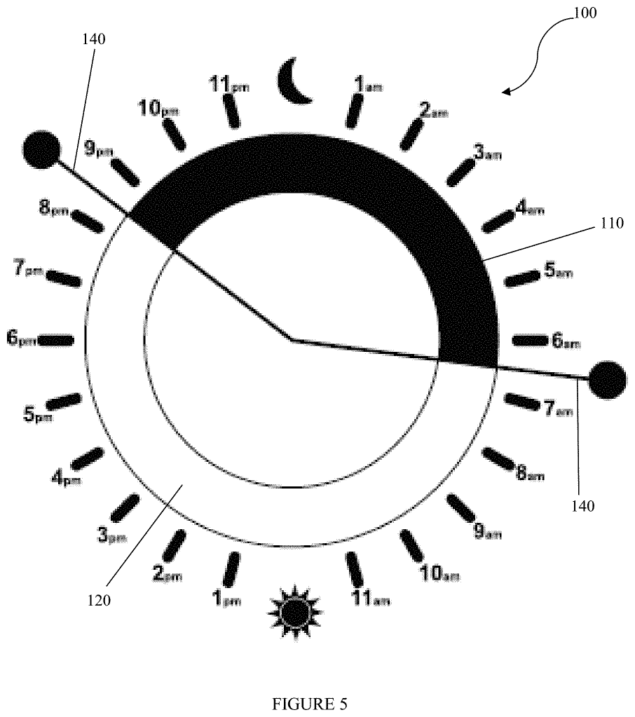

Turning to FIG. 5, the time cycle typically is a 24 hour daily cycle but may also have different time cycles for different applications. For example, the cycle depicted in the radial timeline 100 may be a yearly annual cycle, such as for transitioning from a first light scene 110 to a second light scene 120 around holidays or special events. In addition, seasonal time cycles, such as compensating for summer/winter solar patterns may be set. Specialty time cycles, such as for tuning lighting systems to match agricultural crop growth patterns may also be set. As depicted in FIG. 5, the cycle may show precise times around the radial configuration 100 depending on the time cycle selected.

As outlined above, the radial cycle may include graphic or numeric representations of time cycles. For example, a sun icon to represent noon and a crescent moon icon to represent midnight may be incorporated into the radial configuration 100.

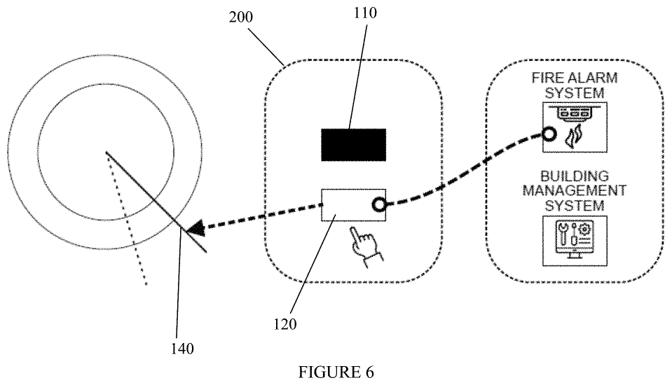

The presets are not set in stone. In certain embodiments they may be overridden as depicted in FIG. 6. Indeed, certain lighting scenes or effects may be configured in advance for immediate triggering of lighting effects, to override the time-cycle based control of the primary radial timeline. Examples of immediate triggering include a fire alarm where the user wants all of the lighting in a space on maximum intensity. In such an embodiment, the building management system or fire control system in a space triggers a safety warning and the lighting should automatically set to maximum to ensure occupant egress. In other embodiments, a user may schedule an abnormal situation such as a special event, maintenance, or cleaning during which time the lights are set to a specific scene and to remain on that scene until the situation ends. Indeed, in the case of emergencies such lighting scenes may be preconfigured to remain on indefinitely. Conversely, the user may set the scene to return to the primary timeline at the next set lighting scene or effect transition at a designated end point.

Regardless, the disclosed user interface menu will either list or graphically depict each preset scene, each automatic data input, alarm trigger, control triggers, and static or variable light scenes. Thus, allowing a user to visually tie an input to a scene trigger.

### SYSTEM COMPONENTS

A system includes a general purpose computing device, including a processing unit (CPU or processor), an optional real-time positioning device, a temporal component, and a system bus that couples various system components including the system memory such as read only memory (ROM) and random access memory (RAM) to the processor. The system can include a storage device connected to the processor by the system bus. The system includes a radial interface connected to the processor by the system bus. The system can include a cache of high speed memory connected directly with, in close proximity to, or integrated as part of the processor. The system can copy data from the memory and/or a storage device to the cache for quick access by the processor. In this way, the cache provides a performance boost that avoids processor delays while waiting for data. These and other modules stored in the memory, storage device, or cache can control or be configured to control the processor to perform various actions. Other system memory may be available for use as well. The memory can include multiple different types of memory with different performance characteristics.

Computer Processor

The system and method can operate in a computing environment with more than one processor or on a group or cluster of computing devices networked together to provide greater processing capability. The processor can include any general purpose processor and a hardware module or software module, stored in an external or internal storage device, configured to control the processor as well as a special purpose processor where software instructions are incorporated into the actual processor design. The processor can be a self-contained computing system, containing multiple cores or processors, a bus, memory controller, cache, etc.

For clarity of explanation, an illustrative system embodiment is presented as including individual functional blocks including functional blocks labeled as a “processor”. The functions such blocks represent may be provided through the use of either shared or dedicated hardware, including, but not limited to, hardware capable of executing software and hardware, such as a processor, that is purpose-built to operate as an equivalent to software executing on a general purpose processor. For example, the functions of one or more processors may be provided by a single shared processor or multiple processors and use of the term “processor” should not be construed to refer exclusively to hardware capable of executing software. Illustrative embodiments may include microprocessor and/or digital signal processor (DSP) hardware, read-only memory (ROM) for storing software performing the operations discussed below, and random access memory (RAM) for storing results.

Real-Time Positioning System Component

The real-time positioning system component can be a global positioning system (GPS) component used to identify the current geographic location of the structure and/or computer system as well as its location in relation to another location. The GPS information may be supplemented by other information, such as nearby wireless networks, to determine the current location of the real-time positioning system component. For example, in certain embodiments, the real-time positioning system component may identify its current location by sensing and/or identifying nearby Wi-Fi networks. The real-time positioning system component may be able to identify the geographic location of such Wi-Fi networks and thus, identify its own location based on which Wi-Fi networks it detects and its proximity to the Wi-Fi networks (i.e., Wi-Fi enabled real time tracking). The real-time positioning component may also be a temporal component.

Temporal Component

The temporal component can be a time system used to identify the current time in the geographic location of the structure and/or computer system. Temporal information can be displayed on the system. For example, a clock may be displayed on the mobile device. The temporal information may be supplemented by other information, such as being synchronized with the atomic clock, to determine the exact time.

System Bus

The system bus may be any of several types of bus structures including a memory bus or memory controller, a peripheral bus, and a local bus using any of a variety of bus architectures. A basic input/output (BIOS) stored in ROM or the like, may provide the basic routine that helps to transfer information between elements within the computing device, such as during start-up.

Storage Device

The computing environment can further include a storage device such as a hard disk drive, a magnetic disk drive, an optical disk drive, a solid state drive, a tape drive or the like. Similar to the system memory, a storage device may be used to store data files, such as location information, round prices, rules on round play, discounts related to the rules, software, wired and wireless connection information (e.g., information that may enable the mobile device to establish a wired or wireless connection, such as a USB, Bluetooth or wireless network connection), and any other suitable data. Specifically, the storage device and/or the system memory may store code and/or data for carrying out the disclosed techniques among other data.

In one aspect, a hardware module that performs a particular function includes the software component stored in a non-transitory computer-readable medium in connection with the necessary hardware components, such as the processor, bus, display, and so forth, to carry out the function. The basic components are known to those of skill in the art and appropriate variations are contemplated depending on the type of device, such as whether the device is a small, handheld computing device, a desktop computer, or a computer server.

Although the preferred embodiment described herein employs cloud computing and cloud storage, it should be appreciated by those skilled in the art that other types of computer readable media which can store data that are accessible by a computer, such as magnetic cassettes, flash memory cards, digital versatile disks, cartridges, random access memories (RAMS), read only memory (ROM), a cable or wireless signal containing a bit stream and the like, may also be used in the operating environment. Furthermore, non-transitory computer-readable storage media as used herein include all computer-readable media, with the sole exception being a transitory propagating signal per se.

Interface

To enable user interaction with the computing device, an input device represents any number of input mechanisms, such as a microphone for speech, a touch-sensitive screen for gesture or graphical input, keyboard, mouse, motion input, speech and so forth. An output device can also be one or more of a number of output mechanisms known to those of skill in the art such as a display screen, speaker, alarm, and so forth. In some instances, multimodal systems enable a user to provide multiple types of input to communicate with the computing device. The communications interface generally governs and manages the user input and system output. Furthermore, one interface, such as a touch screen, may act as an input, output and/or communication interface.

There is no restriction on operating on any particular hardware arrangement and therefore the basic features here may easily be substituted for improved hardware or firmware arrangements as they are developed.

Software Operations

The logical operations of the various embodiments disclosed are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the recited methods, can be a part of the recited systems, and/or can operate according to instructions in the recited non-transitory computer-readable storage media. Such logical operations can be implemented as modules configured to control the processor to perform particular functions according to the programming of the module. For example, if a storage device contains modules configured to control the processor, then these modules may be loaded into RAM or memory at runtime or may be stored as would be known in the art in other computer-readable memory locations. Having disclosed some components of a computing system, the disclosure now turns to a description of cloud computing, on which both the system and method may operate.

Cloud computing is a type of Internet-based computing in which a variety of resources are hosted and/or controlled by an entity and made available by the entity to authorized users via the Internet. A cloud computing system can be configured, wherein a variety of electronic devices can communicate via a network for purposes of exchanging content and other data. The system can be configured for use on a wide variety of network configurations that facilitate the intercommunication of electronic devices. For example, each of the components of a cloud computing system can be implemented in a localized or distributed fashion in a network.

Cloud Resources

The cloud computing system can be configured to include cloud computing resources (i.e., “the cloud”). The cloud resources can include a variety of hardware and/or software resources, such as cloud servers, cloud databases, cloud storage, cloud networks, cloud applications, cloud platforms, and/or any other cloud-based resources. In some cases, the cloud resources are distributed. For example, cloud storage can include multiple storage devices. In some cases, cloud resources can be distributed across multiple cloud computing systems and/or individual network enabled computing devices. For example, cloud computing resources can communicate with a server, a database, and/or any other network enabled computing device to provide the cloud resources.

In some cases, the cloud resources can be redundant. For example, if cloud computing resources are configured to provide data backup services, multiple copies of the data can be stored such that the data is still available to the user even if a storage resource is offline, busy, or otherwise unavailable to process a request. In another example, if a cloud computing resource is configured to provide software, the software can be available from different cloud servers so that the software can be served from any of the different cloud servers. Algorithms can be applied such that the closest server or the server with the lowest current load is selected to process a given request.

User Terminals

A user interacts with cloud computing resources through user terminals connected to a network by direct and/or indirect communication. Cloud computing resources can support connections from a variety of different electronic devices, such as servers, desktop computers, mobile computers, handheld communications devices (e.g., mobile phones, smart phones, tablets), set top boxes, network-enabled hard drives, and/or any other network-enabled computing devices. Furthermore, cloud computing resources can concurrently accept connections from and interact with multiple electronic devices. Interaction with the multiple electronic devices can be prioritized or occur simultaneously.

Cloud computing resources can provide cloud resources through a variety of deployment models, such as public, private, community, hybrid, and/or any other cloud deployment model. In some cases, cloud computing resources can support multiple deployment models. For example, cloud computing resources can provide one set of resources through a public deployment model and another set of resources through a private deployment model.

In some configurations, a user terminal can access cloud computing resources from any location where an Internet connection is available. However, in other cases, cloud computing resources can be configured to restrict access to certain resources such that a resource can only be accessed from certain locations. For example, if a cloud computing resource is configured to provide a resource using a private deployment model, then a cloud computing resource can restrict access to the resource, such as by requiring that a user terminal access the resource from behind a firewall.

Service Models

Cloud computing resources can provide cloud resources to user terminals through a variety of service models, such as Software as a Service (SaaS), Platforms as a service (PaaS), Infrastructure as a Service (IaaS), and/or any other cloud service models. In some cases, cloud computing resources can provide multiple service models to a user terminal. For example, cloud computing resources can provide both SaaS and IaaS to a user terminal. In some cases, cloud computing resources can provide different service models to different user terminals. For example, cloud computing resources can provide SaaS to one user terminal and PaaS to another user terminal.

User Interaction

In some cases, cloud computing resources can maintain an account database. The account database can store profile information for registered locations. The profile information can include user resource access rights, such as software that the user is permitted to use, maximum storage space, etc. The profile information can also include usage information, such as computing resources consumed, data storage location, security settings, personal configuration settings, etc. In some cases, the account database can reside on a database or server remote to cloud computing resources such as servers or database.

Cloud computing resources can provide a variety of functionality that requires user interaction. Accordingly, a user interface (UI) can be provided for communicating with cloud computing resources and/or performing tasks associated with the cloud resources. The UI can be accessed via an end user terminal in communication with cloud computing resources. The UI can be configured to operate in a variety of client modes, including a fat client mode, a thin client mode, or a hybrid client mode, depending on the storage and processing capabilities of cloud computing resources and/or the user terminal. Therefore, a UI can be implemented as a standalone application operating at the user terminal in some embodiments. In other embodiments, a web browser-based portal can be used to provide the UI. Any other configuration to access cloud computing resources can also be used in the various embodiments.

### ENVIRONMENTAL COMPONENTS

The disclosed system and method can be linked to numerous adjustable environmental components within a structure. For example, as outlined above, the adjustable environmental component may be a light fixture thereby allowing the user to adjust the color, temperature or intensity of the lighting on the inside and/or outside of the structure. In addition, such environmental components may be individually adjusted to set different scenes. For example, the system and method allows the user to control lighting for a variety of different rooms or environments within the structure sot that different environments or rooms have different lighting scenes throughout a typical routine cycle.

In certain embodiments, the adjustable environmental component may be a HVAC system. As a result, the system may be adapted to control the HVAC systems for different parameters throughout the day, including temperature, humidity, fan speed, etc.

In certain embodiments, the adjustable environmental component may be electrical generation and storage infrastructure such as solar panels and batteries. In such embodiments, the system may control whether solar power generated at the solar cells is routed to storage or routed to the grid. The system may also control how battery storage is used. For example, during certain designated time periods, the batteries can be drawn down, during other time periods the batteries can be recharged, and during still other time periods the power generated can be routed to the electrical grid (i.e., sold). Furthermore, as outlined above, environmental components can be linked. As a result, the system can identify what time periods is it acceptable to shed internal load by, for example, dimming lighting or reducing air conditioning to either charge the batteries or sell power to the grid.

In certain embodiments, the adjustable environmental component may be a security system. For such embodiments, the system and method may activate or shut down different security protocols at different times of the day or week. Furthermore, as outlined above, the security system may be set to override presets of other environmental components. For example, if the security system detects via an occupancy sensor an individual in an environment in the structure, they should not be in the system may override certain environmental components and turn on all the lights in the structure.

In certain embodiments, the adjustable environmental component is at least one digital sign. In such embodiments, the system or method may control power to the system. Furthermore, the system may control what content is displayed at certain time. For example, the system may display commercials during morning commute; art during afternoon; or holiday lighting throughout the year)

In certain embodiments, the adjustable environmental components are window shades. In such embodiments, the system raises and lowers the shades to control light infiltration into the structure.

In certain embodiments, the adjustable environmental components are vertical transport systems, such as elevators or escalators, with the structure. In such embodiments the system may realign the floor location of stationary elevators based on the time of day. Furthermore, the direction of escalators may also be changed based on the time of day.

While this subject matter has been disclosed with reference to specific embodiments, it is apparent that other embodiments and variations can be devised by others skilled in the art without departing from the true spirit and scope of the subject matter described herein.

What is claimed is:

1. A system for managing a structural environment with a user interface having a timeframe identified by a radial chronological representation, the system comprising:
a software application. operating on a mobile computer device or on a computer device that is synced with the mobile computer device, the software application configured to receive a structure identifier and a target environment profile linked to preferences for the structural environment, the target environment profile created by an owner, employee or agent of the structure using the radial chronological representation and to communicate the structure identifier and target environment profile through a wired and/or wireless communication network to a server located at the structure or a location remote to the structure through the wired and/or wireless communication network; and
a processor in communication through a wired and/or wireless communication network with the software application, the server, and a temporal component, wherein upon communication of the structure identifier and the target environment profile the processer is configured to call up from a database of the system at least one identifier of an adjustable environmental component located at the structure linked to the structural environment, the identifier having been previously uploaded to the database and linked to the structure environment by the owner, employee or agent of the structure, the processor is further configured to receive a current date and time from the temporal component;
whereby the processor is configured to determine the current desired operational state of the adjustable environmental component by comparing the date and time to the target environment profile;
whereby the processor is configured to compare the current operational state of the adjustable environmental component to the current desired operational state of the adjustable environmental component and to adjust the current operational state of the adjustable environmental component to match the current desired operational state of the adjustable environmental component;
whereby the processor is further configured to continuously receive the date and time from the temporal component and continuously determine the current desired operational state of the adjustable environmental component by comparing the date and time to the target environment profile; and
whereby die processor is further configured to actively, monitor the current operational state of the adjustable environmental component and determine whether the current operational state matches the current desired operational state of the adjustable environmental component and when the current operational state does not match the current desired operational state the processor is configured to adjust the current operational state of the adjustable environmental component to match the current desired operational state of the adjustable environmental component.

2. The system of claim 1, wherein the radial chronological representation is defined by two concentric circles.

3. The system of claim 2, wherein the radial chronological representation includes at least two adjustable radial linear dividers designating at least two separate sections of the radial chronological representation.

4. The system of claim 1, wherein the radial chronological representation defines a twenty-four hour time period.

5. The system of claim 1, wherein the target environment profile is created by the owner, employee or agent of the structure using both the radial chronological representation and a palette having at least two settings for the adjustable environmental components for the structural environment.

6. The system of claim 5 wherein the target environment profile is created by an owner, employee or agent of the structure using a touch screen and dragging and dropping each setting onto the radial chronological representation.

7. The system of claim 5 wherein the system further includes a sensor adapted to actively monitor the structural environment and continuously transmit data related to the structural environment to the processor and the processor is further adapted to actively monitor the current operational state of the adjustable environmental component and the structural environment and determine whether the structural environment matches the current desired operational state and when the current operational state does not match the current desired operational state the processor is configured to adjust the current operational state of the adjustable environmental component to drive the structural environment to the desired structural environment.

8. The system of claim 7, wherein the palette further includes a sensor icon and the sensor data is incorporated into the target environmental profile by an owner, employee or agent of the structure using a touch screen and dragging and dropping the sensor icon onto the radial chronological representation.

9. The system of claim 7 wherein when the processor is further configured to call up from the database of the system
at least one emergency threshold previously uploaded by the owner, employee or agent of the structure;
at least one override environment linked to the emergency threshold and previously uploaded by the owner, employee or agent of the structure; and
whereby the processor is further configured to actively monitor the structure environment and upon the structural environment crossing the emergency threshold, within a degree of tolerance, the processor is adapted to adjust the current operational state of the adjustable environmental component to match to drive the structure environment to the override environment.

10. A method for managing a structural environment with a user interface having a timeframe identified by a radial chronological representation, the method comprising:
receiving a structure identifier and a target environment profile linked to preferences for the structural environment, the target environment profile created by an owner, employee or agent of the structure using the radial chronological representation;
communicating the structure identifier and target environment profile through a wired and/or wireless communication network;
receiving, upon communication of the structure identifier and the targe environment profile, at least one identifier of an adjustable environmental component located at the structure linked to the structural environment along with a current date and time;
determining the current desired operational state of the adjustable environmental component by comparing the current date and time to the target environment profile;
comparing the current operational state of the adjustable environmental component to the current desired operational state of the adjustable environmental component;
adjusting the current operational state of the adjustable environmental component to match the current desired operational state of the adjustable environmental component;
monitoring, continuously, the date and time and determining, continuously, the current desired operational state of the adjustable environmental component by comparing the date and time to the target environment profile; and
monitoring, continuously, the current operational state of the adjustable environmental component and determine, continuously, whether the current operational state matches the current desired operational state of the adjustable environmental component and when the current operational state does not match the current desired operational state adjusting the current operational state of the adjustable environmental component to match the current desired operational state of the adjustable environmental component.

11. The method of claim 10, wherein the radial chronological representation is defined by two concentric circles.

12. The method of claim 11 wherein the radial chronological representation includes at least two adjustable radial linear dividers designating at least two separate sections of the radial chronological representation.

13. The method of claim 10, wherein the radial chronological representation defines a twenty-four hour tine period.

14. The method of claim 10, wherein the target environment profile is created by the owner, employee or agent of the structure using both the radial chronological representation and a palette having at least two settings for the adjustable environmental components for the structural environment.

15. The method of claim 14 wherein the target environment profile is created by an owner, employee or agent of the structure using a touch screen and dragging and dropping each setting onto the radial chronological representation.

16. The method of claim 10 wherein the continuous monitoring is accomplished by a sensor located within the structural environment.

17. A system for managing a structural environment with a user interface having a timeframe identified by a radial chronological representation, the system comprising:
a website accessible through a wired or wireless communications network by a unique mobile computer device that is synced to a software application operating on the unique mobile computer device, whereby the unique mobile computer device is assigned a unique registered customer credential the software application configured to receive a structure identifier and a target environment profile linked to preferences for the structural environment, the target environment profile created by an owner, employee or agent of the structure using the radial chronological representation and to communicate the structure identifier and target environment profile through a wired and/or wireless communication network to a server located at the structure or a location remote to the structure through the wired and/or wireless communication network; and
a processor in communication through a wired and/or wireless communication network with the software application, the server, and a temporal component, wherein upon communication of the structure identifier and the target environment profile the processer is configured to call up from a database of the system at least one identifier of an adjustable environmental component located at the structure linked to the structural environment, the identifier having been previously uploaded to the database and linked to the structure environment by the owner, employee or agent of the structure, the processor is further configured to receive a current date and time from the temporal component;
whereby the processor is configured to determine the current desired operational state of the adjustable environmental component by comparing the date and time to the target environment profile;
whereby the processor is configured to compare the current operational state of the adjustable environmental component to the current desired operational state of the adjustable environmental component and to adjust the current operational state of the adjustable environmental component to match the current desired operational state of the adjustable environmental component;
whereby the processor is further configured to continuously receive the date and time from the temporal component and continuously determine the current desired operational state of the adjustable environmental component by comparing the date and time to the target environment profile; and
whereby the processor is further configured to actively monitor the current operational state of the adjustable environmental component and determine whether the current operational state matches the current desired operational state of the adjustable environmental component and when the current operational state does not match the current desired operational state the processor is configured to adjust the current operational state of the adjustable environmental component to match the current desired operational state of the adjustable environmental component.

18. The system of claim 17, wherein the radial chronological representation is defined by two concentric circles.

19. The system of claim 18, wherein the radial chronological representation includes at least two adjustable radial linear dividers designating at least two separate sections of the radial chronological representation.

20. The system of claim 17, wherein the radial chronological representation defines a twenty-four hour time period.
